(19) United States
(12) Patent Application Publication
(10) Pub. No.: US 2003/0089363 A1
(43) Pub. Date: May 15, 2003

(54) Masonry splitting apparatus and related method

(76) Inventors: Antal Z. Suto, Elburn, IL (US); John A. Campau, Zeeland, MI (US)

Correspondence Address: WARNER NORCROSS & JUDD LLP, 900 FIFTH THIRD CENTER, 111 LYON STREET, N.W., GRAND RAPIDS, MI, 49503-2487, US

(21) Appl. No.: 10/044,620

(22) Filed: Nov. 9, 2001

(51) Int. Cl. B28D 1/02

(52) U.S. Cl. 125/23.01; 125/40

(57) ABSTRACT

A concrete block splitter including an anti-backdrive holding blade, a rigid cutting table, and a lower cutting blade. The present invention provides a masonry splitter that splits blocks or bricks starting from the bottom side of the block, which typically includes the most dense material, so that a resultant fracture propagates along a uniform plane through the block. The anti-backdrive holding blade firmly clamps the block onto the rigid table during a splitting operation in such a manner that the blade does not move relative to the rigid table. Accordingly, during a splitting operation, the block is prevented from moving and the blade is prevented from deflecting. The cutting blade contacts the bottom surface of the block with sufficient force to propagate a fracture through the block. In the preferred embodiment, the splitter is mounted on self-powered wheels for easy installation and removal from an automated block production line.

### BACKGROUND

The present invention relates to a masonry block or brick splitter.

Architectural building walls and landscape retaining walls are commonly constructed from individual concrete blocks having a rough or textured appearance on the outside face of the walls. The rough appearance is created by splitting a wide block into two parts with a splitting blade.

Many machines have been developed to perform block splitting operations automatically. One such machine is disclosed in U.S. Pat. No. 2,881,753 to Entz. The Entz splitter includes upper and lower cutting chisels oriented in a vertical plane perpendicular to a cutting table on which a block is split. The cutting table includes a slot through which the lower cutting blade travels. The table is further vertically movable and pivots about the slot. To split a block, an in-feed conveyor first positions the block on the cutting table. The cutting chisel moves upward, contacts the block, and forces both the block and the cutting table upward so that the block contacts and raises the upper chisels until the chisels engage the contours of the upper surface of the block. Next, the lower cutting chisel forcibly drives the block against the upper chisel and simultaneously splits the block. The table pivots about the slot causing the slot to open up so that debris drops through the slot, away from the cutting blade.

Known brick splitters, such as the one disclosed in Entz, suffer a number of shortcomings. First, the upper chisels and cutting table are movable with respect to one another. Therefore, during the cutting operation, the block is not clamped with a consistent force between the upper chisel and the table. Moreover, blocks must make a transition from the elevation of an in-feed conveyor to the upper chisel and back down to the conveyor which adds unnecessary movement in the process. Second, the use of a pivoting table in a splitting operation causes a block to bend or deflect as the lower cutting blade penetrates the block, which causes uneven split propagation. Third, conventional block cutters may inadvertently split weak or partially fractured blocks as the lower chisels lift the blocks upward toward the upper chisels.

### SUMMARY OF THE INVENTION

To overcome the aforementioned problems, the present invention takes advantage of a discovery that the lower surface of a block typically includes a higher material density than the upper surface because the higher density materials used to manufacture the block typically settle toward the bottom due to vibration used to compact the concrete mix while forming the block. Accordingly, it is undesirable to apply a splitting force with a blade to the top surface of the block, because this will cause the block to propagate at undesirable angles through the less dense materials and form a non-homogenous block face. Therefore, the present invention provides a masonry splitter including: a rigid table for supporting a block; an anti-backdriving blade for contacting a top surface of a block and pressing the block against the rigid fixed table; and a cutting blade opposedly aligned with the holding blade for splitting the block from the block's lower surface.

In the preferred embodiment, the rigid cutting table and anti-backdriving screw member are mounted to a rigid support frame so that the two are stationary relative to one another during a splitting operation. The table is preferably rigid to prevent deflection and movement of the block as the block is split. Optionally, both the anti-backdrive screw member and rigid cutting table are adjustable to accommodate blocks of varying sizes and dimensions.

In a more preferred embodiment, the anti-backdriving screw of the splitter is driven by a motor, hydraulics or pneumatics to retract and extend the holding blade away from and toward a block. In the extended position, the screw member firmly positions the holding blade against the top surface of a block and clamps (but does not cut) the block against a rigid table. The anti-backdriving screw member includes threads with a pitch sufficient to prevent the member from backdriving when a force is applied against the holding blade during a splitting operation

The present invention provides a splitter that splits blocks starting from the most dense surface of the block to reduce irregular fracture propagation and therefore increase consistency of the rough appearance between blocks. The rigid table prevents block bending and deflection of the cutting blade during a splitting operation. The anti-backdriving screw member firmly presses and maintains the concrete block against the rigid table, so that the cutting blade can make a penetrating split from the bottom of the block.

These and other objects, advantages and features of the invention will be more readily understood and appreciated by reference to the detailed description of the preferred embodiments and the drawings.

### BRIEF DESCRIPTION OF THE DRAWINGS

FIG. 1 is shows a front view of a splitter in accordance with the preferred embodiment of the present invention;

FIG. 2 is a top plan view of the splitter;

FIG. 3 is a side elevational view of the splitter in a production line;

FIG. 4 is a side elevation view of the splitter in a production line as the holding blade contacts an upper surface of a block;

FIG. 5 is a side elevation view of the splitter in a production line as the block is initially split;

FIG. 6 is a side elevation view of the splitter in a production line after the block is split; and

FIG. 7 is a front view of an alternative embodiment of the splitter including side cutters.

### DETAILED DESCRIPTION OF THE PREFERRED EMBODIMENTS

I. General Description

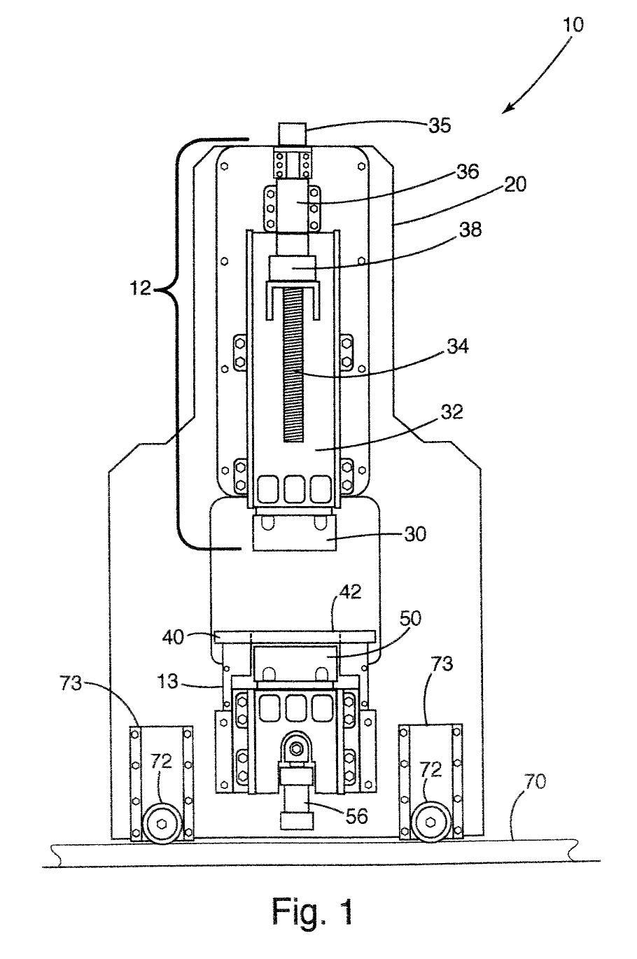

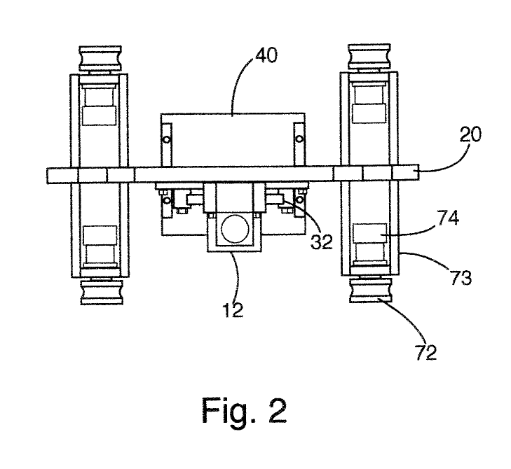

A brick splitter in accordance with a preferred embodiment of the present invention is shown in FIGS. 1 and 2 and generally designated 10. In general, the splitter 10 includes support frame 20 to which upper holding system 12, rigid table 40 and lower cutting system 13 are mounted. The upper holding system 12 includes anti-backdrive holding blade 30 rigidly mounted to holding plate 32, which is movably mounted to threaded drive 34, which is movably mounted to drive motor 35, which is rigidly mounted to support frame 20. Rigid table 40 is likewise rigidly mounted to support frame 20 so that when a work piece is positioned on rigid table 40, and holding blade 30 is pressed against the work piece, that work piece is fixedly clamped between the table 40 and the holding blade 30, which may be straight or a series of angled segments. The cutting blade 50, which may also be straight or a series of angled segments, of the lower cutting system 13 is disposed below the rigid table 40 so that during a cutting operation it travels upward through an aperture 42 in the rigid table 40 to contact the lower portion of a work piece clamped between the table and the holding blade 30. The lower hydraulic system 56 drives the cutting blade and pressed against the lower portion of that work piece with sufficient force to fracture the work piece through a vertical plane or series of consecutive vertical planes coincident with holding blade 30.

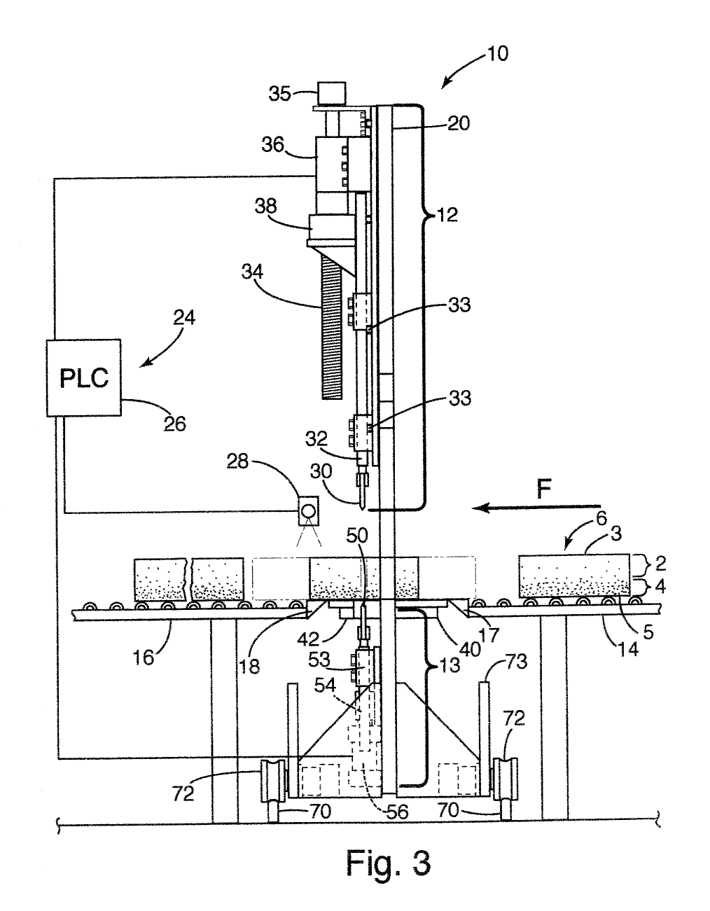

With further reference to FIG. 3, the splitter is preferably movable on tracks 70 via wheels 72 which are driven by power motors 74 mounted to the support frame 20. Located on opposite feed and discharge sides of the splitter 10 are in-feed conveyor 14 and a discharge or outflow conveyor 16, which transports blocks, bricks or other masonry units toward the splitter 10 and after cutting or splitting thereof, transport split material from the splitter 10, respectively. Preferably a block split by the splitter are loaded onto the conveyor 14 immediately after they are manufactured and cured so that the blocks 6 are oriented with the more compact and higher density aggregate portion 4 of the block material is on the “bottom,” and the low density portion 2 of the block material is on the “top.” This is because in conventional block making processes, the higher density ingredients in a concrete mix settle out toward the bottom of the block.

In the preferred embodiment, when the block 6 is positioned on rigid table 40 and held in place by holding blade 30, the cutting blade 50 may fracture the block 6 from the bottom side adjacent the high density portion. Fracturing a block in this way propagates fractures consistently along a predetermined plane and reduces geometric variations of the resultant surfaces along the split. Because the splitter 10 of the present invention does not cut into the upper portion 2 of the block with the holding blade 30, no objectionable tooling marks are scored on the resultant block face and the block is cut uniformly on a desired relatively homogeneous plane to create an aesthetically pleasing face on the block.

II. Cutting Table

FIGS. 1-3 show the table 40 mounted to support frame 20. The table 40 is preferably rigid so that as blocks are cut on it, it does not allow the blocks to bend or deflect, and subsequently cause a cutting blade to leave objectionable tooling marks on the split face. The table may be a single or multiple pieces of hardened steel or other material suitable for repeatedly contacting abrasive masonry units without significant wear. The rigid table 40 is preferably fixedly mounted to support frame 20 with bolts. However, any other fastening means may be used, for example, screws or by welding. The rigid table is configured so that it substantially supported on both sides by the support frame 20. Accordingly, the rigid table 40 does not flex or deflect substantially when a block 6 is clamped down upon it by the holding blade 30. The table 40 includes an aperture 42 through which cutting blade 50 may travel and contact the lower surface of a block 6 resting on the table and fracture that block. Optionally, the aperture 42 may be a slot defined by the table or the surface of the table may be divided into two separate and parallel members through which the cutting blade 50 may travel.

In operation in a production line, the table 40 is preferably along the same horizontal plane as the upper surfaces of conveyor systems 14, 16 as depicted in FIG. 3. The conveyor systems 14, 16 or the table 40, or the support frame 20 may include bridges 17, 18 to provide support for block 6 as it moves to and from the fixed table from the in-feed conveyor 14 and discharge conveyor 16.

III. Upper Holding System

With reference to FIGS. 1 and 3, the upper holding system 12 includes holding blade 30, holding plate 32, threaded coupler 38, threaded member 34, drive motor 35 and thrust bearing 36. The drive motor 35 is fixedly mounted to support frame 20 and receives threaded drive member 34 in a rigid coupling, capable of rotating the threaded member 34 within the coupler 38 but not allowing the threaded member to move in relation to the drive motor. Threaded member 34 is preferably supported by thrust bearing 36 which is fixedly mounted to support frame 20. The thrust bearing 36 is of any commercially available rotating mechanism that allows the threaded member to rotate within when driven by drive motor 35, but prevents the threaded member 34 from translating vertically on the axis of the threaded member.

The threaded member 34 may be any threaded device including a pitch or structure that engages the threaded coupler 38 and drive motor 35 in such a manner to prevent the holding blade 30 from being driven away from a work piece 6 as it is split by the lower cutting blade 50 during a splitting operation. Such a mechanism is referred to herein as “anti-backdrive mechanism.” Optionally, the configuration of the threaded drive 34 and coupler 38 may be reversed, that is, the coupler may be fixedly mounted to the support frame 20 and the drive motor 35 may be mounted to the holding plate 32 (not shown). This configuration would operate similar to that described above, except that the drive motor interacts with the threaded member 34, and in particular, the pitch of threads thereon, so that the threaded member 34 does not rotate within the drive motor 35 thereby causing the holding plate 32 and holding blade 30 to retract from a work piece as it is split from the bottom by the cutting blade 50.

Preferably, the threaded member 34 is an acme screw having threads at a pitch sufficient to achieve the function as described above. Optionally, a ball screw or other similar threaded device may be substituted for the Acme screw.

In the preferred embodiment of FIGS. 1 and 3, the coupler 38 is secured to the holding plate 32. The holding plate 32 is preferably movable within the vertical plane that is coincident with the movement of the cutting blade 50. To ensure the holding plate and cutting blade 30 move within this plane, the holding plate is guided by guides 33 which are secured to the support frame 20.

The holding blade 30 is preferably mounted to the holding plate 32 with any structure so that the blade may be easily replaced. For example, the blade 30 may be mounted with bolts or other fasteners. The blade 30 is preferably a typical masonry cutting blade.

As depicted in FIGS. 1 and 3, the holding blade 30 is in a retracted position so that blocks 6 may freely pass onto the rigid table 40 for cutting. The distance between the holding blade 30 and the work piece 6 may be adjusted as desired. Optionally, manual or automatic adjusting motors or brackets may be mounted to the upper holding system 12 to move that system downward to accommodate different sized and dimensioned work pieces 6. The holding blade is drivable by drive motor 35 to a position, an “extended” position where it stalls and clamps down against the top surface 3 of the block 6 thereby clamping the block 6 between the holding blade and the rigid table 40 as described in further detail below.

The drive motor 35 rotates the threaded member 34. Any conventional pneumatic, hydraulic or electrically powered motor may be used. As the motor rotates the threaded member 34, the coupler 38 moves relative to the longitudinal axis of the threaded member 34 to extend or retract the holding blade 30 toward or away from the rigid table 40.

As will be appreciated by those skilled in the art, the upper holding system 12 may be in duplicate, that is, more than one upper cutting system may be mounted to the support frame 12, adjacent one another to allow splitting of multiple concrete blocks simultaneously on the table. Optionally, the holding blades 30 of the these multiple upper holding systems may be linked together to split individual single, large masonry units. As will be appreciated, if multiple upper holding systems 12 are included in the splitter 10, then a corresponding number of cutting systems 13 may likewise be used in the splitter 10. Optionally, single large cutting system 13 may be used in conjunction with multiple upper holding systems 12, or conversely, multiple cutting systems 13 may be used with a single upper holding system 12 as desired.

IV. Cutting System

With reference to FIGS. 1 and 3, the cutting system 13 generally includes cutting or lower blade 50 which is mounted to thrust plate 54 which is further mounted to cutting press 56 which is itself mounted to the support frame 20. The cutting press 56 is preferably a hydraulic, pneumatic, cam-driven or electric power press capable of driving the thrust plate 54 and attached cutting blade 50 upward into a work piece with sufficient force to split the work piece into separate parts.

The thrust plate 54 is preferably mounted to a ram of the cutting press 56. The thrust plate 54 preferably travels in a plane, as depicted, a vertical plane, coincident with the holding blade 30 of the holding system 12. The thrust plate 54 is preferably guided by guides 53 which are fixably mounted to the support frame 20. The cutting blade 50 is extendable and retractable by the cutting press 56 a sufficient distance to exert the force necessary to split a work piece; that is, the cutting blade 50 is extendable through aperture 42 of the rigid table 40 to contact and split a work piece clamped on the table 40 by the holding blade 30.

The cutting blade 50 may be constructed of any commercially available material suitable for cutting masonry units. Optionally, the cutting blade is fastened to the thrust plate 54 so that it may be easily replaced, such as with bolts or other fasteners as described above in connection with the holding blade 30.

V. Portable Splitter

As depicted in FIGS. 1-3, the splitter 10 is outfitted with wheels 72 so that the splitter may be moved into and out from various conveyor systems for maintenance or production line charges. The extremely narrow profile of the splitter 10 of the present invention allows this additional option. Preferably, wheels 72 are rotatably mounted to the support frame 20. The wheels may be of any configuration. For example, the wheels 72 may be substituted with lockable casters. However, as shown, they are keyed to fit on track system 70. Wheels 72 are preferably mounted to the support member 20 with mounting bracket 73 in such a manner that the support frame 20 may be adjusted vertically to accommodate different height conveyor systems. Optionally, this feature may be absent from the splitter 10.

Preferably, the wheels 72 are powered by independent motors that are mounted to the support frame 20 or mounting bracket 73. Similarly, a single motor used in conjunction with axle shafts, sprockets, chains, or other commercially available power transmission components may be used to drive one or more wheels. As will be appreciated, the motors may be absent and the splitter 10 may be manually movable. These motors may be any commercially available motor suitable for powering drive wheels and moving the splitter 10.

VI. Side Cutting Blades

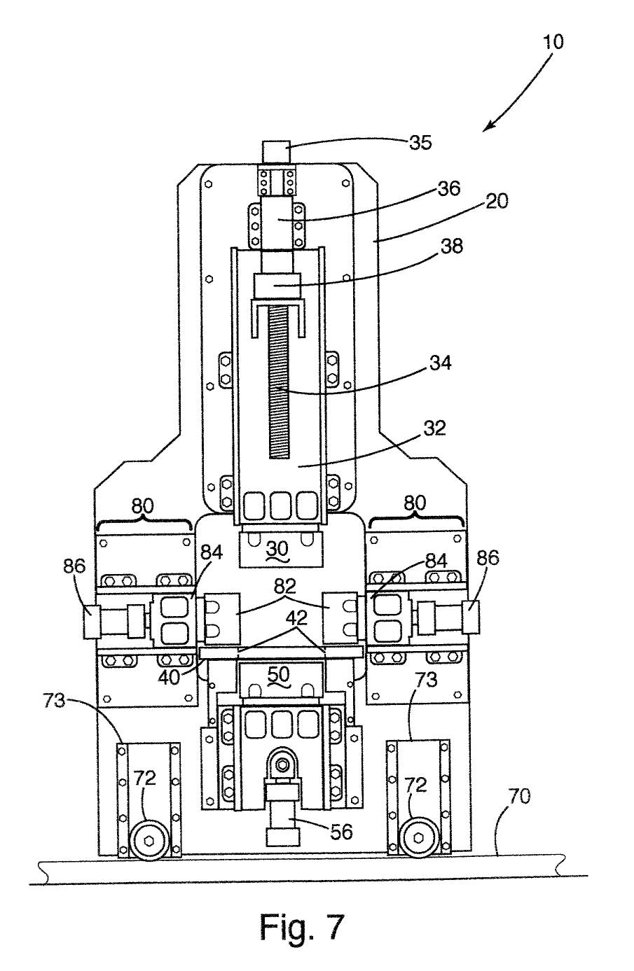

Optionally, as depicted in FIG. 7, the splitter 10 of the present invention may be further retrofitted to include side cutters 80. The side cutters include a side cut drive 86 coupled to side cut plates 84, to which side cut blades 82 are mounted. The components of the side cutters are similar to that of the cutting system 13 described above and therefore for the sake of brevity will not be explained again here. Notably, the side cutters extend and retract side cutting blades 82 within the plane coincident with the holding blade 30 and the cutting blade 50 and assist in splitting work pieces during a splitting operation. Optionally, manual or automatic adjusting motors or brackets may be mounted to the side cutters 80 to move that system horizontally to accommodate different sized and dimensioned work pieces 6 (not shown).

VII. Control System

With further reference to FIG. 3, the splitter 10 may include a control system 24, including a microprocessor 26 and sensor 28, which controls advancement and feed of blocks 6 onto the cutting table 40 and subsequent holding and splitting operations performed by holding system 12 and cutting system 13. Microprocessor 26 may be any commercially available programmable logic computer (PLC). Sensor 28 may be a photosensor or other commercially available sensor to detect positioning of blocks 6. Any number of sensors placed virtually anywhere in relation to the conveyor and/or splitter may be used to control block flow.

VIII. Operation of the Splitter

With reference to FIGS. 3-6, the splitting operation carried out by splitter 10 will now be described. FIG. 3 depicts in-feed conveyor system 14 feeding block 6 onto the rigid table 40 of the splitter 10. As noted above, the block 6 being split is preferably a recently manufactured block having a more dense portion 4 disposed on the lower surface thereof so that that lower surface 5 contacts the rigid table 40 of the splitter 10 and rests thereupon.

The holding system 12 depicted in FIG. 3 is in its retracted position where the holding blade 30 allows blocks to travel across and onto the rigid table 40. Optionally, the positioning system 24 may be used in conjunction with the splitter to variably feed and position the blocks 6 onto the rigid table 40 in any desired manner. For example, if the blocks are to be split in half, the positioning system 24 may position the block so that its mid-portion is positioned precisely below the holding blade. Likewise, if the block is to be cut into thirds, the positioning system 24 would accurately position the block so that it is positioned below the holding blade at positions corresponding to thirds of the block.

In the preferred embodiment, after the block 6 is positioned on the rigid table 40, the drive motor 35 powers “on,” thereby rotating the threaded member 34. Accordingly, the holding blade 30 descends downward into contact with the upper surface 3 of product 6 due to the interaction of the threaded member 34 with the corresponding threaded coupler 38.

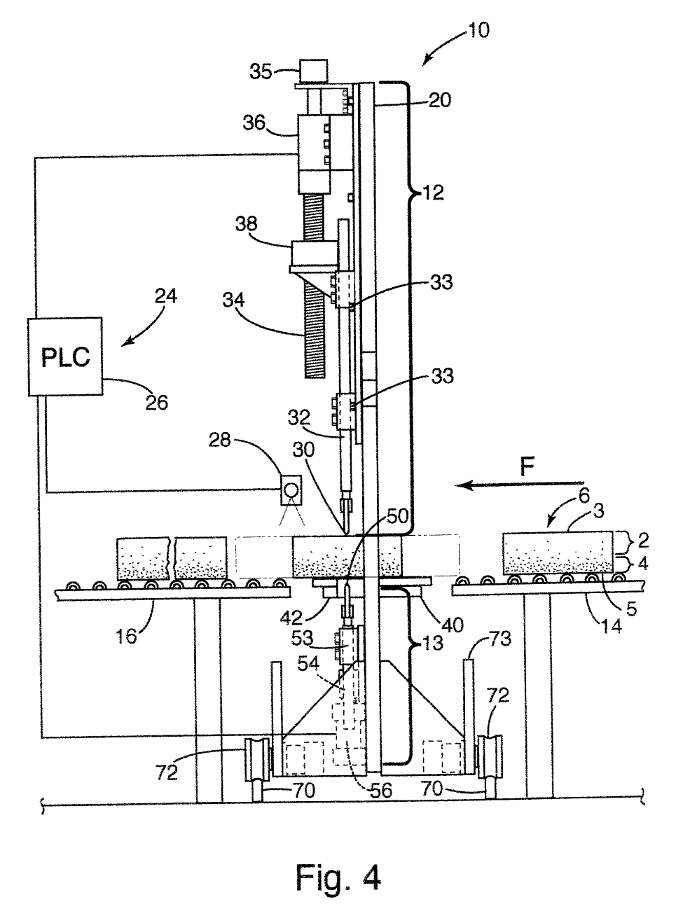

With reference to FIG. 4, as the holding blade 30 contacts the upper surface 3 of the block 6, it drives the block 6 downward against the table 40, thereby clamping the block between the holding blade 30 and the table 40. Because of the pitch of the threaded member 34 and its interaction with the mated threaded drive coupler 38, that threaded member 34 will not backdrive, and consequently the holding blade 30 will not retract in subsequent steps where forces are exerted against the block 6. The drive motor 35 drives the holding blade down 30 with sufficient force to contact the top surface 3 and clamp the block, but not split the top surface 2 of the block. At this point, the drive motor 35 stalls out. The motor is held energized to maintain a constant clamping force on the block.

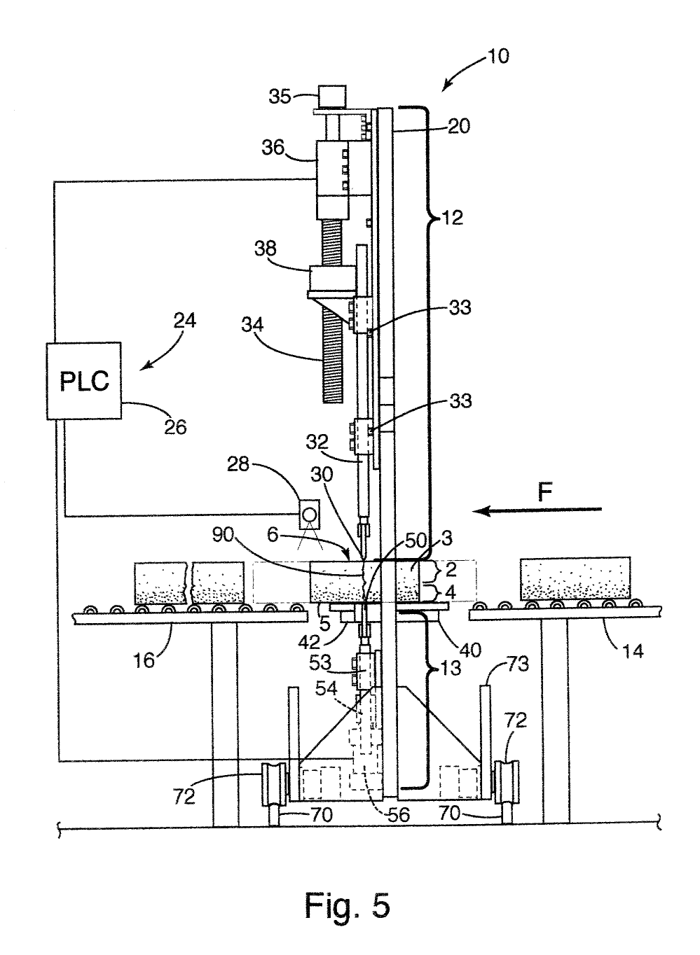

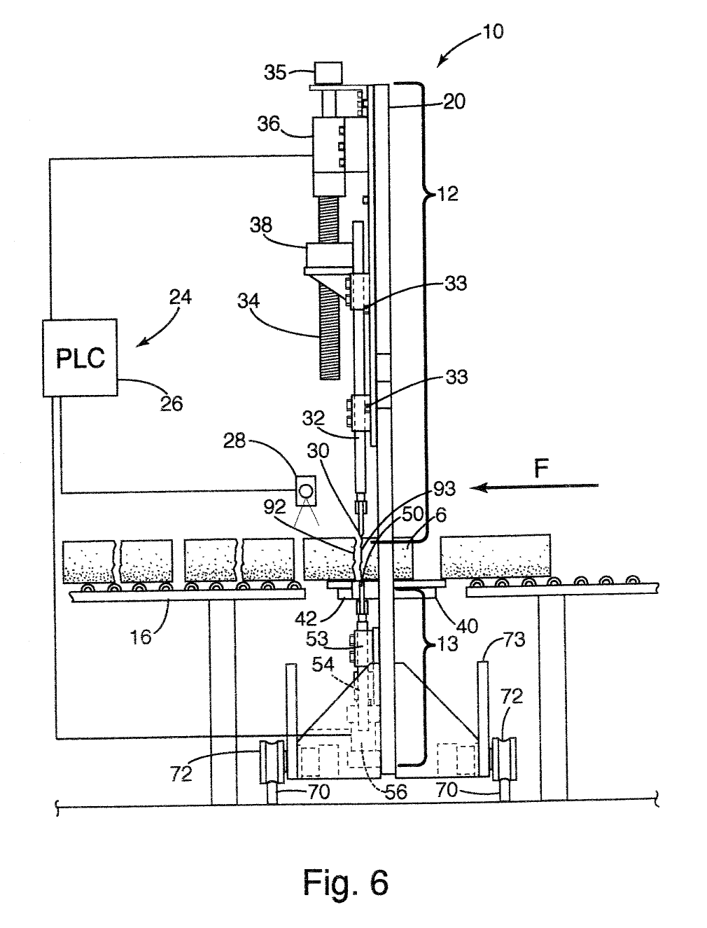

In another step depicted in FIGS. 5 and 6, the cutting blade 50 is extended upward by cutting press 56 through the aperture 42 and the rigid table 40 with sufficient force to split the block 6 starting from the more dense portion 4 adjacent the lower surface 5 of the block. Accordingly, a crack 90 propagates from the lower surface of the block to the upper surface of the block toward the holding blade. Thus, the resultant faces of the block propagate along the desired vertical plane between the holding blade 30 and the cutting blade 50 without significant deviations from the vertical plane. After the crack 90 has fully extended across the depth of the block 6, the faces 92 and 93 are exposed. These faces do not include significant geometric variation from one another. Moreover, because the holding blade 30 is maintained in fixed relation with respect to the table 40, the holding blade 30 does not penetrate into the block to leave objectionable tooling marks on the resultant exposed faces 92 and 93. Finally, because the table 40 remains rigid throughout the splitting operation, the block does not bend or deflect during the cutting operation which may cause an undesirable angle of crack propagation or cause the tooling to leave objectionable marks on the surfaces 92 and 93 of the block 6.

After a block is then satisfactorily split by the splitter 10, the control system 24 causes the cutting blade 50 and holding blade 30 to retract to their unextended positions, as depicted in FIG. 3, and another block is fed unto the rigid table 40 to continue the process.

In the alternative embodiment depicted in FIG. 7, the splitting operation, as described above, is similar except that as the cutting blade 50 contacts the lower surface of the block 5, the side cutters 82 likewise contact the side of the block and almost simultaneously exert a splitting force with the cutting blade 50 to split the blocks from the bottom 5 and the sides as well.

The above descriptions are those of the preferred embodiments of the invention. Various alterations and changes can be made without departing from the spirit and broader aspects of the invention as defined in the appended claims, which are to be interpreted in accordance with the principles of patent law including the doctrine of equivalents. Any references to claim elements in the singular, for example, using the articles “a,” “an,” “the,” or “said,” is not to be construed as limiting the element to the singular.

The embodiments of the invention in which an exclusive property or privilege is claimed are defined as follows:

1. A block splitting device comprising:
a support frame;
a table mounted to said support frame defining an aperture, said table stationary with respect to said support frame;
a drive member rotatably coupled to said support frame above said table;
an upper blade coupled to said drive member;
a motor coupled to said drive member for rotationally translating said drive member so that said upper blade is moved in a vertical plane toward or away from said table, said motor capable of pressing said upper blade against a block on said table during a cutting operation;
an actuator mounted below said table; and
a lower blade coupled to said actuator and aligned to move through said aperture and within the same vertical plane as said upper blade, said lower blade movable by said actuator to split a block from a bottom surface of the block when said block is pressed by said upper blade against said table.

2. The block splitting device of claim 1 wherein said table rigidly supports the work piece during a cutting operation.

3. The block splitting device of claim 2 wherein said drive member is at least one of an acme screw and a ball screw.

4. The block splitting device of claim 3 wherein said drive member is coupled to said support frame with a guide, said guide including a mating portion that mates with a plurality of threads on said drive member.

5. The block splitting device of claim 4 wherein at least one of said mating portion and said plurality of threads includes a pitch sufficient to prevent said drive member from backdriving away from said table when said lower blade splits a block.

6. The block splitting device of claim 5 comprising side cutters to split the block from side surfaces of the block during a cutting operation.

7. The block splitting device of claim 5 comprising a plurality of wheels to move the block splitting device into and out from a production line.

8. An apparatus for splitting a masonry unit from a lower surface of the unit, comprising:
an upper ram including a threaded drive and a holding blade, said threaded device for driving said holding blade in a plane to position said holding blade against an upper surface of the masonry unit;
a table disposed at a preselected angle from said plane, said table and said holding blade interacting to maintain the masonry unit in a stationary position relative to said holding blade and said table during a splitting operation; and
a lower ram including a drive mechanism and splitting blade, said drive mechanism capable of driving said splitting blade in said plane to apply a force sufficient to split the masonry unit from the lower surface as the masonry unit is supported on said table.

9. The apparatus of claim 8 wherein said table rigidly supports the masonry unit so that the masonry unit does not bend before the masonry unit splits during said splitting operation.

10. The apparatus of claim 9 wherein said threaded drive drives said holding blade against the upper surface of the masonry unit to clamp, but not split, the masonry unit against the table.

11. The apparatus of claim 10 wherein said upper ram, and said table are rigidly mounted to a support frame.

12. The apparatus of claim 11 wherein said upper ram does not backdrive away from when the masonry unit during said splitting operation.

13. The apparatus of claim 12 comprising a plurality of wheels mounted to said support frame so that the apparatus may be moved into and out from a masonry unit production line.

14. A splitting apparatus comprising:
a table for supporting a block having a lower surface and an upper surface;
an upper jaw including a screw drive and a first blade coupled to said screw drive, said first blade actuatable by said screw drive in a plane between a retracted position and an extended position wherein said first blade contacts an upper surface of the block and presses the lower surface of the block against said table; and
a lower jaw including a ram and a second blade coupled to said ram, said second blade actuatable by said ram between a rest position and a cutting position wherein said second blade travels in said plane and exerts a sufficient force against the lower surface of the block to fracture the work piece between said first blade and said second blade.

15. The splitting apparatus of claim 14 comprising a plurality of said upper jaws and said lower jaws for simultaneously splitting at least of a large block and multiple small blocks.

16. The splitting apparatus of claim 14 comprising at least one side cutter including a blade to apply a sufficient cutting force to sides of the block to assist in the fracture of the block.

17. The splitting apparatus of claim 14 wherein said screw drive maintains said first blade in said extended position as said second blade fractures the block.

18. The splitting apparatus of claim 14 wherein said table is coupled to a plurality of wheeled elements.

19. The splitting apparatus of claim 19 wherein said wheeled elements interfit on a track system, said track system interposed in a block manufacturing line.

20. A method for cutting masonry units comprising:
feeding a masonry unit that includes a high material density portion and a low material density portion onto a rigid table so that the high material density portion is adjacent the rigid table;
contacting the low material density portion of the masonry unit with a holding blade in a plane so that the high material density portion of the masonry unit is forced into fixed abutment with the rigid table; and
driving a cutting blade into the high material density portion of the masonry unit along the plane whereby the masonry unit is fractured between the holding blade and the cutting blade with the fracture propagating first through the high material density portion and then the low material density portion of the masonry unit.

21. The method of claim 20 comprising maintaining the holding blade and rigid table in fixed relation to one another.

22. The method of claim 20 comprising driving a secondary side blade into the high density material and the low density material along the plane as the fracture propagates.

23. The method of claim 20 wherein the anti-backdriving holding blade is mounted to at least one of an acme screw and a ball screw.

24. The method of claim 22 wherein the holding blade and the rigid table are mounted to a support frame, including at least one motorized wheel.
